(19) United States
(12) Patent Application Publication
(10) Pub. No.: US 2008/0255731 A1
(43) Pub. Date: Oct. 16, 2008

(54) Occupant detection apparatus

(75) Inventors: Hirofumi Mita, Minato-ku (JP); Hiroshi Aoki, Minato-ku (JP); Masato Yokoo, Minato-ku (JP); Yuu Hakomori, Minato-ku (JP)

Correspondence Address: FOLEY AND LARDNER LLP;SUITE 500, 3000 K STREET NW, WASHINGTON, DC, 20007, US

(73) Assignee: Takata Corporation

(21) Appl. No.: 12/081,086

(22) Filed: Apr. 10, 2008

(30) Foreign Application Priority Data
Apr. 12, 2007 (JP) 2007-105120

(51) Int. Cl. G06F 17/00; B60R 21/02; G06K 9/62

(52) U.S. Cl. 701/45; 701/36; 382/103

(57) ABSTRACT

An occupant detection apparatus including a photographing section that is disposed to face to a vehicle rear seat for taking three-dimensional images of the vehicle rear seat area. The apparatus includes an information extraction processing section that extracts only first image information about an upper area of a seat back of the vehicle rear seat area from the three-dimensional images including the first image information and second image information about areas other than the upper area of the seat back. The apparatus also includes a segmentation processing section that segments the first image information extracted by the information extraction processing section into areas relating to respective sitting areas of a plurality of rear-seat occupants. The apparatus further includes a derivation processing section that derives, with regard to each image information segmented by the segmentation processing section, information about the rear-seat occupant sitting in the vehicle rear seat.

### BACKGROUND

The present disclosure relates to an occupant detection technology to be used in a vehicle and, more particularly, a technology for detecting information about rear-seat occupants sitting in a vehicle rear seat.

Conventionally, there are known various techniques for detecting an object occupying a vehicle seat by using a photographing means such as a camera. For example, disclosed in JP-A-2003-294855, is a configuration of a detection apparatus in which a camera capable of two-dimensionally photographing an object is arranged in front of a vehicle occupant to detect the position of the vehicle occupant by the camera.

With regard to a seat belt apparatus to be worn by an occupant sitting in a vehicle rear seat among seat belt apparatuses for restraining occupants by means of seat belts, there is a demand for increasing the seat belt wearing rate by rear-seat occupants. To meet the demand, it is necessary to precisely detect information about occupants sitting in a vehicle rear seat. Such a technology for precisely detecting information about rear-seat occupants is effective not only for the seat belt apparatus for a rear-seat occupant but also for other driving support equipment.

However, it is difficult to precisely detect intended information about rear-seat occupants in the configuration of using a camera two-dimensionally photographing a vehicle occupant. When there is a small difference in color between the background and a rear-seat occupant or a small difference in color between the skin and the clothes, a problem arises that it is difficult to securely detect the rear-seat occupant.

### SUMMARY

According to one disclosed embodiment, an occupant detection apparatus is disclosed. The apparatus may include a photographing device and a controller. The photographing device may be disposed to face to a vehicle rear seat in a vehicle cabin for taking three-dimensional images of the vehicle rear seat area. The images include first image information about an upper area of a seat back of the vehicle rear seat area and second image information about areas other than the upper area of the seat back. The controller may include an information extraction processing section configured to extract only the first image information from the three-dimensional images. The controller also may include a segmentation processing section configured to segment the first image information extracted by the information extraction processing section into areas relating to respective sitting areas of a plurality of rear-seat occupants sitting in the vehicle rear seat; and an derivation processing section configured to derive, with regard to each image information segmented by the segmentation processing section, information about the rear-seat occupant sitting in each sitting area of the vehicle rear seat, based on the percentage of the occupant information occupying a two-dimensional image at a position spaced apart from the photographing device by a reference distance.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an illustration showing a system configuration of an occupant detection apparatus 100 to be installed in a vehicle according to an embodiment.

FIG. 2 is an illustration showing an example of image taken by the 3D camera 112 of the embodiment.

FIG. 3 is an illustration showing an area A1 defined as an upper area of a seat back by an information extraction processing section 151 of this embodiment.

FIG. 4 is an illustration showing aspects in the process by the segmentation processing section 152 of the embodiment.

FIG. 5 is an illustration showing aspects in the process by the image conversion processing section 153 and the image extracting section 154 of the embodiment.

FIG. 6 is an illustration showing an aspect in the process by the occupant information computing section 155 of the embodiment.

FIG. 7 is an illustration showing the arrangement of a computing unit 160 according to another embodiment.

FIG. 8 is an illustration showing a structure of a vehicle to which the occupant detection apparatus 100 shown in FIG. 1 is installed.

### DETAILED DESCRIPTION

Though the present application discloses an occupant detection apparatus typically configured for an automobile for detecting information about rear-seat occupants sitting in a vehicle rear seat, the present invention can be also adapted to a vehicle other than the automobile.

A vehicle may include an engine/running system; an electrical system; a vehicle control device; and an operation device control system, as described in more detail below. The engine/running system is a system involving an engine and a running mechanism of the vehicle. The electrical system is a system involving electrical parts used in the vehicle. The vehicle control device is a device controls the actuation of the engine/running system and the electrical system. The operation device is actuated based on the precisely detected information about the rear-seat occupant in the vehicle rear seat.

According to another exemplary embodiment, a vehicle includes an engine/running system; an electrical system; a vehicle control device, and a seat belt apparatus. The engine/running system is a system involving an engine and a running mechanism of the vehicle. The electrical system is a system involving electrical parts used in the vehicle. The vehicle control device is a device having a function of controlling the actuation of the engine/running system and the electrical system. The seat belt apparatus has a function of restraining a rear-seat occupant sitting in a vehicle rear seat by a seat belt and is composed of a seat belt system, as described in more detail below. The vehicle can be provided with a seat belt apparatus capable of conducting controls using precisely detected information about occupant(s) in the vehicle rear seat by conducting respective processes based on three-dimensional images taken by an occupant detection apparatus.

An occupant detection apparatus may include a photographing section, an information extraction processing section, a segmentation processing section, and a derivation processing section.

The photographing section is disposed to face to a vehicle rear seat in a vehicle cabin for taking three-dimensional images of the vehicle rear seat area. The photographing section may be any suitable device including but not limited to a 3-D type monocular C-MOS camera, a 3-D type pantoscopic stereo camera, or a laser scanner. The photographing section may be provided anywhere in the vehicle facing to the vehicle rear seat. According to one exemplary embodiment, the photographing section is provided in an area around an inner rearview mirror. The vehicle may include one or more of the photographing sections.

The term “vehicle rear seat” is used here to include various vehicle seats arranged in a rear-side portion of a vehicle. The vehicle rear seat may be a seat or seats of the second row from the front (e.g., second-row seating configuration) or any other seats other than seats of the first row from the front in case of a plural-row seating configuration. In addition, the “vehicle rear seat area” used here is a peripheral area of the vehicle rear seat and is typically defined as a front area and an upper area of the seat back and a head rest or an upper area of a seat cushion.

The photographing section takes three-dimensional images including first image information and second image information. The first image information relates to an upper area of the seat back in the vehicle rear seat area and the second image information relates to areas other than the upper area of the seat back. The information extraction processing section selectively extracts only first image information (e.g., information except the second image information about areas other than the vehicle rear seat area) from the three-dimensional images.

Since the three-dimensional images containing distance information taken by the photographing section are used, it is possible to extract information according to the distance. Therefore, even when a rear-seat occupant is photographed with being partially overlapped by a front-seat occupant, image information (three-dimensional image information) of the rear-seat occupant in the seat back upper area of the vehicle rear seat can be precisely extracted. It is advantageous to obtain information about rear-seat occupants from the upper area of a seat back because it is generally unobstructed by front-seat occupants sitting in the vehicle front seats. The upper area of the seat back is typically a volume defined by a pair of horizontal planes and two pairs of vertical planes. The horizontal planes extend through the shoulders of the rear-seat occupant and above the head of the rear-seat occupant. The first pair of vertical planes extend in front of the head of the rear-seat occupant sitting in the vehicle rear seat and behind the head of the rear-seat occupant. The second pair of vertical planes extend on right and left sides of the seat back of the vehicle rear seat.

The segmentation processing section has segments the first image information extracted by the information extraction processing section into areas relating to respective sitting areas of a plurality of rear-seat occupants. Specifically, in case of a vehicle rear seat that is occupied by two passengers, the image information extracted by the information extraction processing section is segmented into two areas. In case of a vehicle rear seat that is occupied by three passengers, the image information extracted by the information extraction processing section is segmented into three areas. This segmentation process sets a characterized detection area for each sitting area.

The derivation processing section derives, with regard to each image information segmented by the segmentation processing section, information about the rear-seat occupant sitting in each sitting area of vehicle rear seat. The derivation section derives the information based on the percentage of the occupant information occupying a two-dimensional image at a position spaced apart from the photographing section by a reference distance. Typically, the derivation process sequentially conducts a process of extracting a two-dimensional image, a process of computing the percentage of occupant information occupying the extracted two-dimensional image, and a process of deriving information about the rear-seat occupant based on the computed percentage of the occupant information. These processes may be conducted by respective separate processing sections or by a single processing section.

The process of extracting a two-dimensional image is typically a process of converting the three-dimensional image into a two-dimensional image as seen from the front of the vehicle, the top of the vehicle, or a side of the vehicle. It is preferable that a reference distance is established by the distance from the photographing section to the position where it is highly likely that a rear-seat occupant will be located. In the process of computing the percentage of the occupant information occupying the extracted two-dimensional image, it is preferable to compute the percentage of the occupant information relative to the total dot number of the two-dimensional image. Accordingly, the size of the rear-seat occupant occupying the two-dimensional image is obtained. The “dot” used here is sometimes called “picture element” or “pixel” which is a colored “point” as a unit composing a digital image, and may contain information about distance (depth), degree of transparency, and the like. A digital image is represented by rectangular dots that are aligned orderly lengthwise and crosswise. In the process of deriving information about the rear-seat occupant based on the computed percentage of the occupant information, it is preferable to compare the percentage of the occupant information occupying the extracted two-dimensional image with a predetermined reference percentage or a predetermined range of percentage. The “information about the rear-seat occupant” used here widely contains the presence or absence, the size, the position, and the height of the rear-seat occupant. Therefore, for example, when the size of the rear-seat occupant occupying the two-dimensional image exceeds a reference value, it is determined that the rear-seat occupant is seated. On the other hand, when the size of the rear-seat occupant occupying the two-dimensional image is below the reference value, it is determined that no rear-seat occupant is seated (the seat is unoccupied).

According to the arrangement of the occupant detection apparatus, it is possible to precisely detect information about a rear-seat occupant in each sitting area of the vehicle rear seat by conducting the respective processes based on three-dimensional images containing distance information. It is preferable that the detected information is used for controls of vehicular assist in a seat belt apparatus for restraining the rear-seat occupant by a seat belt in the event of a vehicle collision and/or an air bag apparatus for restraining the rear-seat occupant by an airbag in the event of a vehicle collision. In addition, according to this arrangement, since only image information corresponding to the seat back upper area in the vehicle rear seat is extracted from the three-dimensional image taken by the photographing section and, further, a two-dimensional image at the position spaced apart from the photographing section by the reference distance is extracted from the image information, it is effective in reducing the processing load of a series of image processes for extracting the two-dimensional image and in reducing the storing area to be required.

According to another embodiment, an occupant detection apparatus comprises at least: a photographing section, an information extraction processing section, a segmentation processing section, and a derivation processing section. The photographing section, the information extraction processing section, and the segmentation processing section have the same structures as the photographing section, the information extraction processing section, and the segmentation processing section mentioned above.

The derivation processing section has a function of deriving, with regard to each image information segmented by the segmentation processing section, information about the rear-seat occupant sitting in each sitting area of the vehicle rear seat, based on the volume of a detected object in each sitting area. Typically, this derivation process is achieved by sequentially conducting a process of computing the volume of a detected object in each sitting area, and a process of deriving information about the rear-seat occupant based on the computed volume of the detected object. These processes may be conducted by respective separate processing sections or by a single processing section.

In the process of deriving information about the rear-seat occupant (e.g., the presence or absence, the size, the position, and the attitude of the rear-seat occupant, etc.), it is preferable to use the result of comparing the computed volume of the detected object with a predetermined reference volume or a predetermined range of volume.

According to the arrangement of the occupant detection apparatus, it is possible to precisely detect information about a rear-seat occupant in each sitting area of the vehicle rear seat by conducting the respective processes based on three-dimensional images containing distance information. It is preferable that the detected information is used for controls of vehicular assist in a seat belt apparatus for restraining the rear-seat occupant by a seat belt in the event of a vehicle collision and/or an air bag apparatus for restraining the rear-seat occupant by an airbag in the event of a vehicle collision.

In addition, according to this arrangement, only image information corresponding to the seat back upper area in the vehicle rear seat is extracted from the three-dimensional image taken by the photographing section and only the volume of the detected object in each sitting area is derived from the image information. Therefore, the processing load of and the storage area required for a series of image processes for extracting the two-dimensional image are reduced.

An operation device control system may include an occupant information detector for detecting information about a rear-seat occupant; and an operation device that is actuated according to the detection result of the occupant information detector. The occupant information detector is composed of an occupant detection apparatus as described above and the operation device is actuated according to the information derived by the derivation processing section of the occupant detection apparatus. According to one embodiment, the operation device may be a component of a seat belt apparatus for restraining the rear-seat occupant by a seat belt in the event of a vehicle collision. According to another exemplary embodiment, the operation device may be a component of an airbag apparatus for restraining the rear-seat occupant by an airbag which deploys in front of or on a side of the rear-seat occupant in the event of a vehicle collision. According to another exemplary embodiment, the operation device may be a component of a device which rises a seat cushion of the vehicle rear seat in the event of a vehicle collision in order to prevent a phenomenon that the rear-seat occupant tends to slide along the seat surface below the seat belt, so-called “submarine phenomenon”. According to still other embodiments, the operation device may be any other suitable device or combination of devices.

According to the arrangement of the operation device control system, the operation device can be actuated based on the precisely detected information about a rear-seat occupant in the vehicle rear seat so that this arrangement is effective for suitably actuating the operation device.

A seat belt system that is installed in a vehicle includes an occupant detection apparatus as described above; a seat belt that can be worn by a rear seat occupant to restrain the rear-seat occupant, a seat belt buckle that is installed in each sitting area of the vehicle rear seat; a tongue that is attached to the seat belt and is latched with the seat belt buckle during the seat belt wearing state; and an informing section.

The informing section of the seat belt system emphasizes the position of at least either of the seat belt buckle and the tongue for each sitting area when an occupant is sitting in the sitting area of the vehicle rear seat based on information derived by the derivation processing section. According to various exemplary embodiments, the informing section may include lighting the seat belt buckle and/or the tongue, protruding the seat belt buckle, sending out the tongue, sliding the tongue up and down, or displaying a message on a monitor panel. The informing section helps inform an occupant of the existence and placement of the seat belt system (e.g., the seat belt buckle and/or the tongue) and facilitate an increase in the rate at which a rear-seat occupant utilizes the seat belt system.

According to another exemplary embodiment, the informing section may be configured to inform the occupant if the seat belt buckle and the tongue are properly latched. According to the arrangement of the seat belt system, the informing section can therefore help improper wrong latching such as a case that the tongue for the left side rear-seat occupant is latched with the seat belt buckle for the right side rear-seat occupant.

A seat belt system of another aspect of the present invention includes an occupant detection apparatus as described above; a seat belt that can be worn by a rear seat occupant sitting in a vehicle rear seat for restraining the rear-seat occupant; a seat belt buckle that is installed in each sitting area of the vehicle rear seat; a tongue that is attached to the seat belt and is latched with the seat belt buckle during the seat belt wearing state; a buckle detecting sensor for detecting that the tongue is latched with the seat belt buckle; and an output section. The output section in the seat belt system indicates whether the seat belt system is being properly utilized as determined by a determination processing section of the occupant detection apparatus and the detection result by the buckle detecting sensor. The output section is composed of a monitor panel or a meter panel capable of displaying the detection result or a speaker for outputting voice guidance. According to one embodiment, the output section may urge front-seat occupants or rear-seat occupants to wear the seat belt when the rear-seat occupants do not wear the seat belt. The output section helps facilitate an increase in the rate at which a rear-seat occupant utilizes the seat belt system.

As described in the above, the present invention enables precise detection of information about rear-seat occupants on a vehicle rear seat.

The occupant detection apparatus 100 includes a 3D camera 112, an information extraction processing section 151 for extracting first image information about an upper area of a seat back of a vehicle rear seat, a segmentation processing section 152 for segmenting the first image information, an image conversion processing section 153, an image extracting section 154, and an occupant information computing section 155 for deriving information about the rear-seat occupant sitting in each sitting area of the vehicle rear seat, and a determination processing section 156.

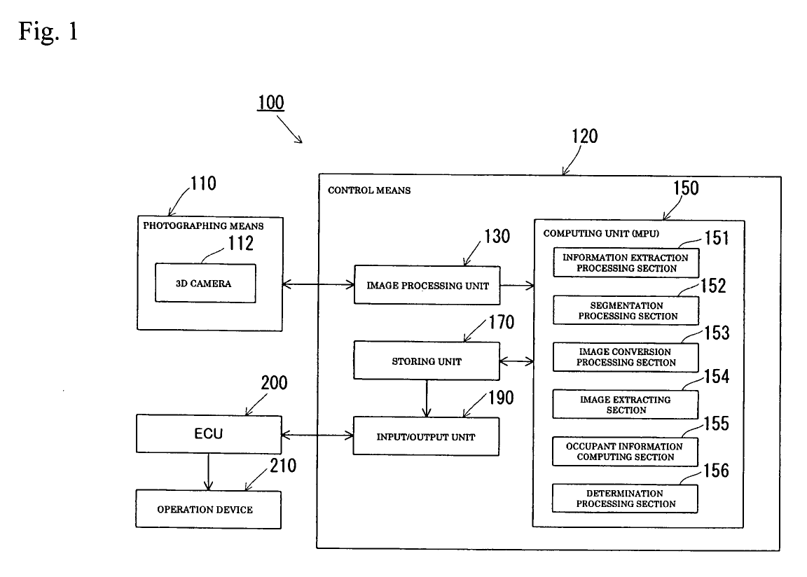

FIG. 1 shows an occupant detection apparatus 100 according to one exemplary embodiment. As shown in FIG. 1, the occupant detection apparatus 100 of this embodiment is installed in an automobile for detecting information about a rear-seat occupant and mainly comprises a photographing means 110 and a control means 120. Further, the occupant detection apparatus 100 cooperates with a vehicle control device or ECU 200 as an actuation control device for the vehicle, and with an operation device 210 to operate a vehicle aiding system such as a seat belt system.

The photographing means 110 of this embodiment includes a 3D camera 112 and a data transfer circuit. The 3D camera 112 is a 3-D (three-dimensional) camera or monitor. According to one exemplary embodiment, the camera 112 is a C-MOS or CCD (charge-coupled device) device in which light sensors are arranged into an array (lattice) structure. 3D camera 112 is configured to record a three-dimensional images from a single view point. Thus, distance relative to the object is measured a plurality of times to detect a three-dimensional surface profile of an object, thereby identifying various characteristics of the object (e.g., the presence or absence, the size, the position, the attitude, etc.). According to various exemplary embodiments, the 3D camera 112 may be a 3-D type monocular C-MOS camera or a 3-D type pantoscopic stereo camera. The photographing means 110 (and the 3D camera 112) corresponds to the “photographing section which is disposed to face to a vehicle rear seat in a vehicle cabin for taking three-dimensional images” described above. According to other exemplary embodiments, photographing means 11 may instead include a laser scanner capable of obtaining three-dimensional images.

The camera 112 of this embodiment is mounted in the automobile such that it faces a predetermined range for movement in a rear portion of the vehicle cabin. According to various exemplary embodiments, the camera 112 may be mounted to an area around an inner rearview mirror, an area around a side mirror, a central portion in the lateral direction of a dashboard, or any other suitable area in or on the vehicle. The “predetermined range for movement” used here may be typically defined as an area where the head and the upper body of an occupant sitting in the vehicle rear seat may exist (a seat back upper area) in an accommodation area in the vehicle cabin. This range may include front-seat occupant(s) and front seat(s). By using the 3D camera 112, information about a rear-seat occupant sitting in the vehicle rear seat is measured periodically a plurality of times.

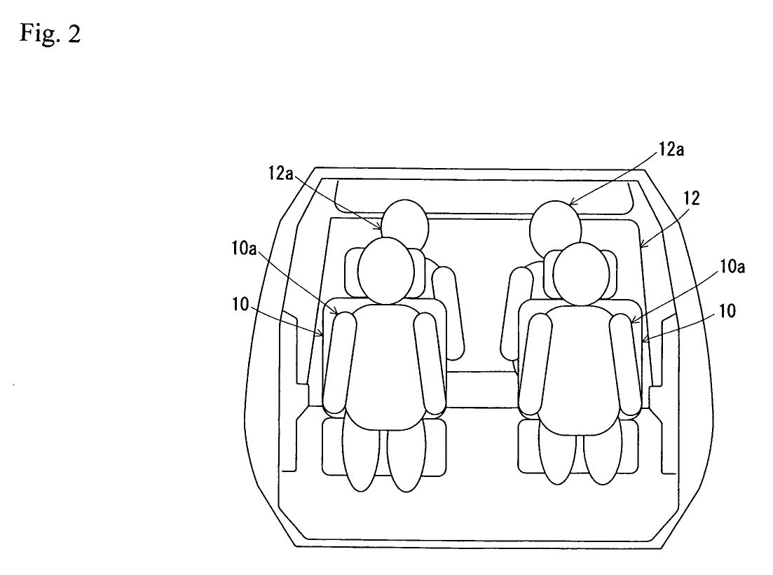

FIG. 2 shows an example of image photographed by the 3D camera 112. In the example shown in FIG. 2, there are front-seat occupants 10a sitting in vehicle front seats 10 and rear-seat occupants 12a sitting in a vehicle rear seat 12 behind the front-seat occupants 10a so that the rear-seat occupants in partial view of the camera 112. The vehicle rear seat 12 is a seat or seats of the second row from the front in case of a second-row seating configuration and seats other than seats of the first row from the front in case of a plural-row seating configuration.

A power source unit (not shown) for supplying power from a vehicle buttery to the 3D camera 112 is mounted on the occupant detection apparatus 100. The camera 112 is set to start its photographing operation when the ignition key is turned ON or when a seat sensor (not shown) installed in the driver seat detects an occupant sitting in the driver seat.

The control means 120 includes at least an image processing unit 130, a computing unit (MPU) 150, a storing unit 170, an input/output unit 190, and peripheral devices (not shown). The control means 120 is configured as an occupant information processing unit (CPU) for processing the information about occupants based on images taken by the 3D camera 112.

The image processing unit 130 controls the camera to control the dynamic range and otherwise obtain good quality images and controls the image processing for processing images taken by the 3D camera 112 to be used for analysis. For example, the image processing may control the camera by monitoring and adjusting the frame rate, the shutter speed, and the sensitivity, and the accuracy correction, the brightness, and the white balance. The image processing may control image preprocessing operations (e.g. monitoring and adjusting the spin compensation for image, the correction for distortion of the lens, the filtering operation, the difference operation, etc.) and image recognition processing operations (e.g., the configuration determination and the trucking).

The computing unit 150 includes at least an information extraction processing section 151, a segmentation processing section 152, an image conversion processing section 153, an image extracting section 154, an occupant information computing section 155, and a determination processing section 156. According to various exemplary embodiments, two or more of the information extraction processing section 151, the segmentation processing section 152, the image conversion processing section 153, the image extracting section 154, the occupant information computing section 155, and the determination processing section 156 may be suitably combined according to the arrangement or function.

The camera 112 takes three-dimensional images including first image information and second image information. The first image information relates to an upper area of the seat back in the vehicle rear seat area and the second image information relates to areas other than the upper area of the seat back. The information extraction processing section selectively extracts only first image information (e.g., information except the second image information about areas other than the vehicle rear seat area) from the three-dimensional images. The “vehicle rear seat area” used here is a peripheral area of the vehicle rear seat 12 and is typically defined as a front area and an upper area of the seat back and a head rest or an upper area of a seat cushion.

The information extraction processing section 151 extracts information about the rear-seat occupants based on the information from the image processing unit 130. The information extraction processing section 151 selectively extracts (derives) only first image information (e.g., information except the second image information about areas other than the vehicle rear seat area) from the three-dimensional images. In the information extraction processing section 151, it is preferable to digitalizing a three-dimensional surface profile detected by the 3D camera 112 by converting the surface profile into a coordinate system as a numerical coordinate. The coordinate system may be an orthogonal coordinate system, a polar coordinate system, a nonorthogonal coordinate system, or a generalized coordinate system, or any other suitable coordinate system.

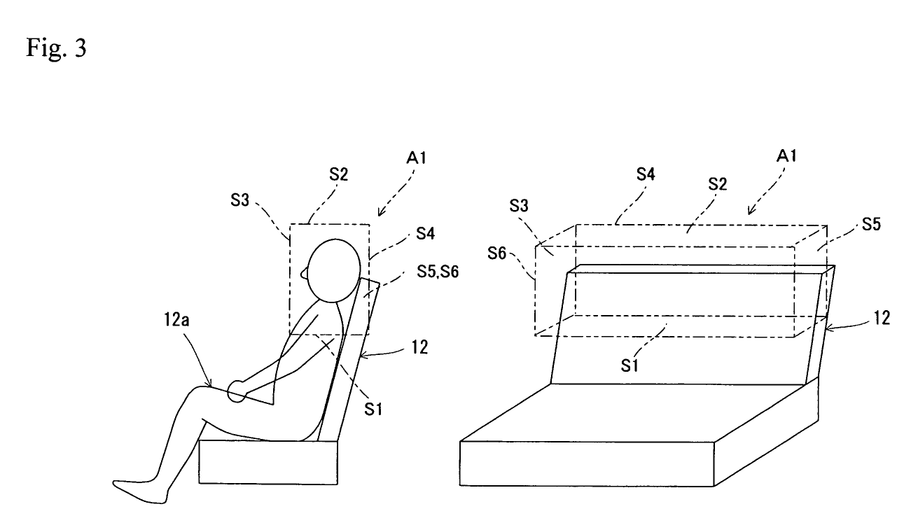

FIG. 3 shows an area A1 that is defined as the seat back upper area by the information extraction processing section 151. The area A1 shown in FIG. 3 is volume that is defined by a horizontal plane S1 extending through the shoulders of the occupant sitting in the vehicle rear seat 12, a horizontal plane S2 extending above the head of the rear-seat occupant sitting in the vehicle rear seat 12, a vertical plane S3 extending in front of the head of the rear-seat occupant sitting in the vehicle rear seat 12, a vertical plane S4 extending behind the head of the rear-seat occupant sitting in the vehicle rear seat 12, and vertical planes S5, S6 extending on right and left sides of the seat back of the vehicle rear seat 12.

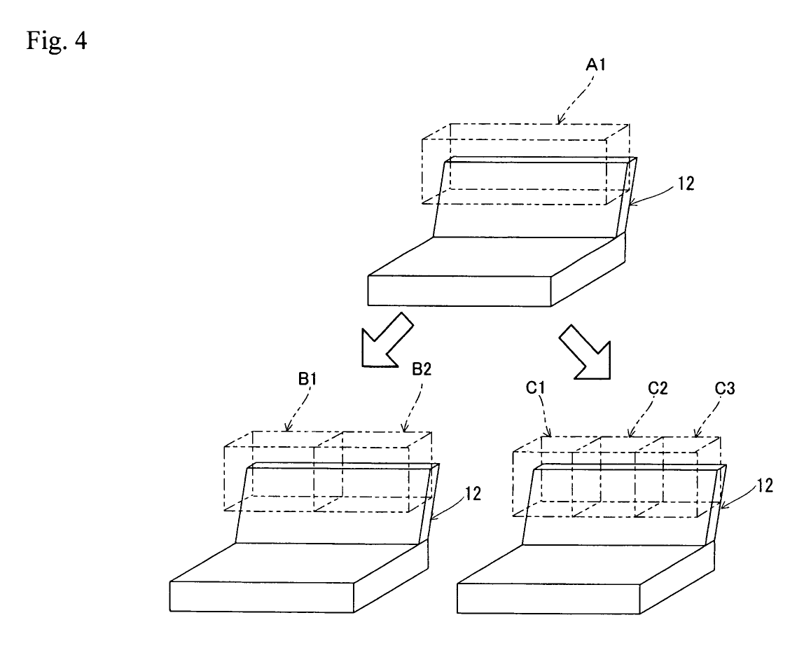

The segmentation processing section 152 segments the image information (first image information of the seat back upper area) extracted by the information extraction processing section 151 into areas for respective occupants sitting in the vehicle rear seat. Specifically, in case of a vehicle rear seat with a capacity of two passengers, the segmentation processing section 152 segments the image information extracted by the information extraction processing section 151 into two areas. As shown in FIG. 4, the information extraction processing section 151 may segment the area A1 into two areas, i.e. segmented areas B1 and B2. In case of a vehicle rear seat with a capacity of three passengers, the segmentation processing section 152 segments the image information extracted by the information extraction processing section 151 into three areas. As shown in FIG. 4, the information extraction processing section 151 may segment the area A1 into three areas, i.e. segmented areas C1 through C3. It should be understood that the information about the passenger capacity of the vehicle rear seat of the subject vehicle is previously stored in the storing unit 170. This segmentation process may be called a process of setting a characterized detection area for each sitting area. The segmented areas formed by segmenting the area A1 are assumed as detection areas where features of a rear-seat occupant can be detected.

The image conversion processing section 153 converts the image information (three-dimensional information) in each segmented area obtained by the segmentation processing section 152 into a two-dimensional image as seen from the front of the vehicle. If necessary, instead of the two-dimensional image as seen from the front of the vehicle, a two-dimensional image as seen from the top of the vehicle or a two-dimensional image as seen from a side of the vehicle may be employed.

The image extracting section 154 extracts (distills) a two-dimensional image at a position spaced apart from the 3D camera 112 by a reference distance from the two-dimensional image converted by the image conversion processing section 153. It is preferable that the distance from the 3D camera 112 to the position where it is highly likely that a rear-seat occupant exists is set as the reference distance and is stored in the storing unit 170.

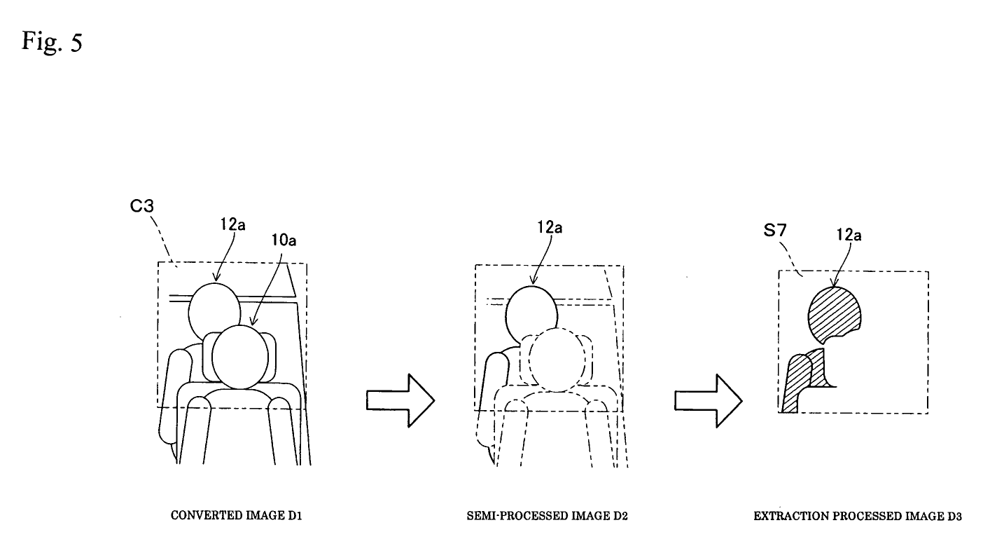

FIG. 5 shows an image such as a converted image D1. Converted image D1 is formed when the image conversion processing section 153 converts the image information (three-dimensional information) in the segmented area C3 obtained by the segmentation processing section 152 into a two-dimensional image as seen from the front of the vehicle. As the image extracting section 154 extracts an image at the position spaced apart from the 3D camera 112 by the reference distance from the converted image D1, an extraction processed image (two-dimensional image) D3 of a reference plane S7 is obtained through a semi-processed image D2.

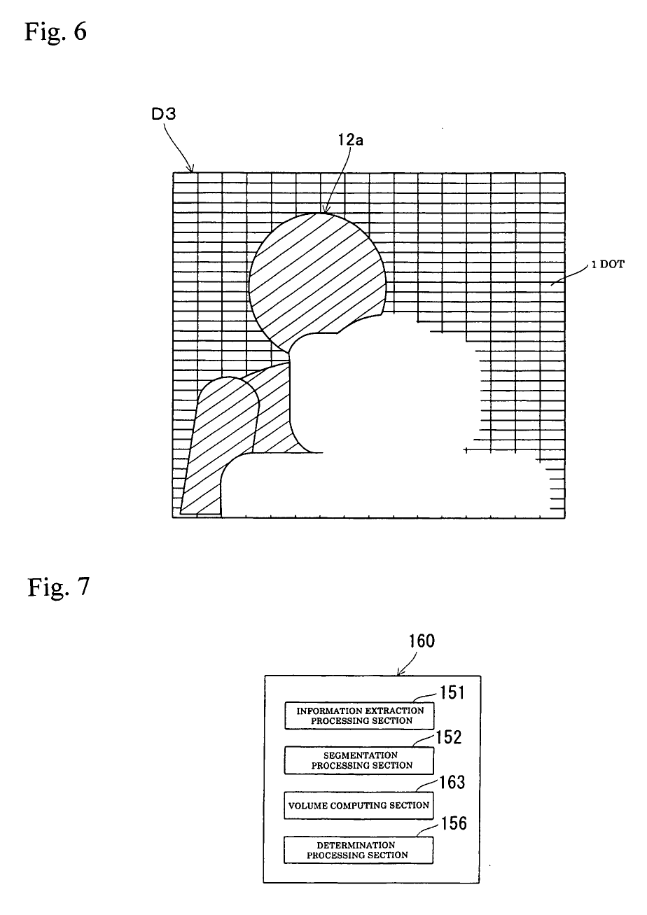

The occupant information computing section 155 computes the percentage of occupant information occupying the two-dimensional image extracted by the image extracting section 154. As shown in FIG. 6, the occupant information computing section 155 computes the percentage of the occupant information relative to the total dot number (for example, 16×35 dots) of the extraction processed image D3 in FIG. 5. Accordingly, the size of the rear-seat occupant occupying the extraction processed image D3 is obtained. The “dot” used here is sometimes called “picture element” or “pixel” and is generally understood to be a colored “point” as a unit composing a digital image, and may contain information about distance (depth), degree of transparency, and the like. A digital image is represented by a sheet of image composed of square or rectangular dots that are aligned orderly lengthwise and crosswise.

The determination processing section 156 determines, based on the information computed by the occupant information computing section 155, whether or not the detected object detected in each segmented area includes a rear-seat occupant. Specifically, when the percentage of the occupant information relative to the total dot number of the extraction processed image D3 exceeds a reference value, the determination processing section 156 determines that a rear-seat occupant is seated. On the other hand, when the percentage is below the reference value, the determination processing section 156 determines that no rear-seat occupant is seated (the seat is unoccupied). This determination process and the processes to be conducted prior to the determination process (the processes by the image conversion processing section 153, the image extracting section 154, and the occupant information computing section 155) are conducted for every segmented area of the two or three segmented areas obtained by the segmentation processing section 152. The determination processing section 156, the image conversion processing section 153, the image extracting section 154, and the occupant information computing section 155 as mentioned above cooperate together to compose “derivation processing section” of the present invention. It should be noted that the determination processing section 156 may be adapted to determine, based on the information computed by the occupant information computing section 155, the size, position, and/or attitude of the rear-seat occupant in addition to or instead of the presence or absence of the rear-seat occupant, if required.

The storing unit 170 stores (records) data for correction, buffer frame memory for preprocessing, defined data for recognition computing, reference patterns, and the computed results of the computing unit 150 as well as an operation control software.

The input/output unit 190 inputs information about the vehicle, information about traffic conditions around the vehicle, information about weather condition and about time zone as well as the determination results by the determination processing section 156 to the ECU 200 for conducting controls of the entire vehicle and outputs recognition results. Information about the vehicle may include, for example, collision prediction information of the vehicle by a radar or camera, the state (open or closed) of a vehicle door, the wearing of the seat belt, the operation of brakes, the vehicle speed, and the steering angle. In this embodiment, based on the information outputted from the input/output unit 190, the ECU 200 outputs actuation control signals to the operation device 210. The input/output unit 190 may be of any structure capable of outputting a control signal to the operation device 210. As shown in FIG. 1, the input/output unit 190 may output a control signal to the operation device 210 indirectly through the ECU 200 or may directly output a control signal to the operation device 210. The operation device 210 corresponds to “operation device” described above.

According to the occupant detection apparatus 100 of this embodiment, as mentioned above, it is possible to precisely detect information about the rear-seat occupant(s) sitting in the vehicle rear seat 12 by conducting the respective processes based on three-dimensional images taken by the 3D camera 112. Using three-dimensional images containing distance information ensures high degree of precision in detection as compared to the case of using two-dimensional images because information can be extracted according to distances even when there is a small difference in color between the background and the rear-seat occupant or a small difference in color between the skin and the clothes.

In this embodiment, since only first image information about the seat back upper area in the vehicle rear seat 12 is extracted 3D image and a two-dimensional image at the position spaced apart from the 3D camera 112 by the reference distance is extracted from the first image information, it is effective in reducing the processing load of a series of image processes for extracting the two-dimensional image and in reducing the storing area to be required.

According to another exemplary embodiment, a computing unit 160 may include a volume computing section 163 instead of the image conversion processing section 153, the image extracting section 154, and the occupant information computing section 155. The arrangement of the computing unit 160 of the different embodiment is shown in FIG. 7. The volume computing section 163 shown in FIG. 7 computes the volume of the detected object in each sitting area based on the image information (three-dimensional information) about each segmented area obtained by the segmentation processing section 152. The determination processing section 156 determines based on the volume of the detected object computed by the volume computing section 163 whether or not the detected object detected in each segmented area includes a rear-seat occupant. Specifically, when the computed volume of the detected object exceeds a reference value, the determination processing section 156 determines that a rear-seat occupant is seated. On the other hand, when the volume is below the reference value, the determination processing section 156 determines that no rear-seat occupant is seated (the seat is unoccupied). This determination process and the volume computing process as the process to be conducted prior to the determination process are conducted for every segmented area of the two or three segmented areas obtained by the segmentation processing section 152. The determination processing section 156 and the volume computing section 163 cooperate together to compose the “derivation processing section” described above. The computing unit 160 having the aforementioned arrangement can exhibit the same works and effects as the case of using the computing unit 150.

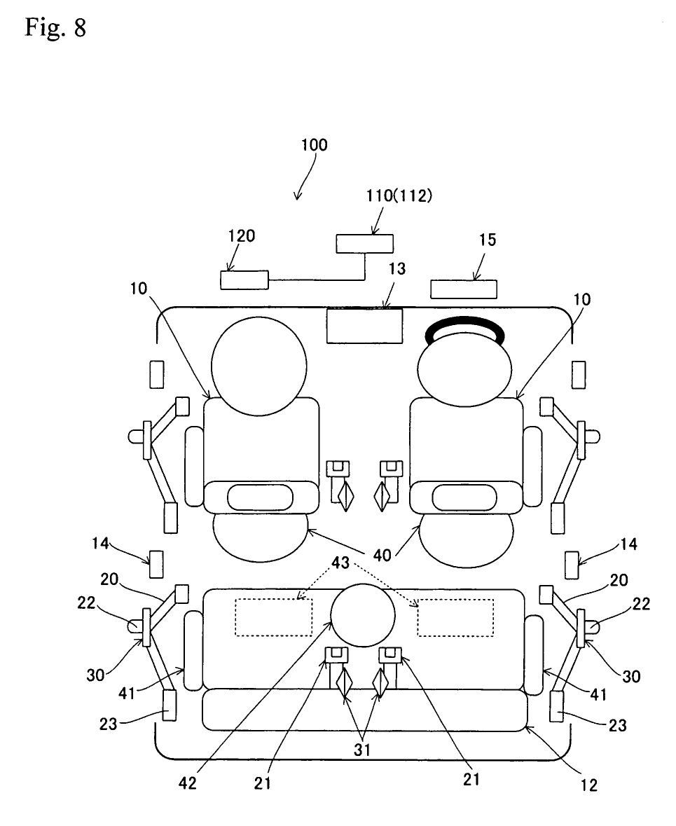

The operation device 210 may be used as a component of seat belt apparatuses or an airbag apparatus. The seat belt apparatus and the airbag apparatus used here correspond to the “operation device control system” described earlier. Especially, the seat belt apparatus corresponds to the “seat belt system” described earlier. FIG. 8 shows a structure of a vehicle to which the occupant detection apparatus 100 shown in FIG. 1 is installed.

According to one exemplary embodiment, a first seat belt apparatus is provided which has an informing mechanism of informing the rear-seat occupant of the positions of a seat belt buckle 21 and a tongue 22 for a seat belt 20 worn by the rear-seat occupant or the selection of the seat belt buckle 21 and the tongue 22, using information about the rear-seat occupant (the presence or absence of occupant, the seated position of the occupant) or information about the getting on/off of the occupant and the information about opening/closing of a vehicle door. According to various exemplary embodiments, the informing section may include lighting the seat belt buckle 21 and/or the tongue 22, protruding the seat belt buckle 21, sending out the tongue 22, sliding the tongue 22 up and down, or displaying a message on a monitor panel. The informing mechanism used here can compose the “informing section” described above. It should be noted that the information about opening/closing of the vehicle door is detected by a vehicle door sensor 14.

The seat belt apparatus having the aforementioned structure helps inform an occupant of the existence and placement of the seat belt system (e.g., the seat belt buckle 21 and/or the tongue 22) and facilitate an increase in the rate at which a rear-seat occupant utilizes the seat belt system.

As a second embodiment, a second seat belt apparatus is provided which has an informing mechanism of informing a driver of the seat belt wearing completion (wearing state) of the rear-seat occupant, using information about the rear-seat occupant (the presence or absence of the occupant, the seated position of the occupant). In the informing mechanism, the informing action may be carried out by displaying on the monitor panel 13 or a meter panel 15 or outputting voice guidance from a speaker. The informing mechanism used here can compose the “informing section” described above.

By using the seat belt apparatus having the aforementioned structure, it can urge front-seat occupants including the driver and the rear-seat occupant(s) to wear the seat belt when the rear-seat occupant(s) sitting does not wear the seat belt.

As a third embodiment, a third seat belt apparatus is provided which has an informing mechanism of informing the driver or the rear-seat occupant of whether or not a tongue 22 is latched with a right seat belt buckle 21, using information about the rear-seat occupant (the presence or absence of the occupant, the seated position of the occupant). In the informing mechanism, the informing action may be carried out by displaying on the monitor panel 13 or a meter panel 15 or voice output, or lightening or vibrating a certain portion. The informing mechanism used here can compose the “informing section” described above.

By using the seat belt apparatus having the aforementioned structure, it can prevent wrong latching such as a case that the tongue for the left side rear-seat occupant is latched with the seat belt buckle for the right side rear-seat occupant, thereby fulfilling the primary occupant restraining function of the seat belt.

As a fourth embodiment, a fourth seat belt apparatus is provided which has a seat belt wearing promoting function for urging the rear-seat occupant to wear the seat belt 20, using information about the rear-seat occupant (the presence or absence of the occupant, the seated position of the occupant). The seat belt wearing promoting function may be carried out by protruding the seat belt buckle 21, sending out the tongue 22, or driving another member (seat belt reacher) acting on the seat belt 20 by a driving device 30 or 31. By using the seat belt apparatus having the aforementioned structure, it is possible to actively urge the rear-seat occupant to wear the seat belt 20.

The seat belt 20, the seat belt buckle 21 and the tongue 22 of each of the seat belt apparatuses as mentioned above correspond to “seat belt”, “seat belt buckle” and “tongue” of the present invention, respectively.

As a fifth embodiment, a fifth seat belt apparatus is provided which actuates a pretensioner 23 for winding up the seat belt 20 to remove any slack of the seat belt 20 in the event of a vehicle collision, using information about the rear-seat occupant (the presence or absence of the occupant, the seated position of the occupant) and, as another information, information about latching between the seat belt buckle and the tongue. By using the seat belt apparatus as mentioned above, the pretensioner 23 can be suitably actuated to wind up the seat belt 20 to remove the slack of the seat belt 20 in the event of a vehicle collision, thereby improving the occupant restraining property by the seat belt.

As a sixth embodiment, an operation device is provided which has a function of actuating an airbag or the like for restraining a rear-seat occupant, using information about the rear-seat occupant (the presence or absence of the occupant, the seated position of the occupant). The operation device may be composed of an airbag 40 which is disposed in a portion under the vehicle front seat 10 or in a cabin ceiling and can be deployed in front of the rear-seat occupant in the event of a vehicle collision, a side airbag 41 which can be deployed at a door side of the rear-seat occupant in the event of a vehicle collision, or an intermediate airbag 42 which can be deployed between the rear-seat occupants in the event of a vehicle collision. Further, the operation device may be composed of a limiting device 43 which rises a seat cushion of the vehicle rear seat 12 by an airbag or another actuating mechanism in order to prevent a phenomenon that the rear-seat occupant tends to slide along the seat surface below the seat belt, so-called “submarine phenomenon”, or a device which provides a curtain-like member between the vehicle front seats 10 and the vehicle rear seat 12 to partition them in order to prevent the rear-seat occupant and/or an object such as baggage from moving forward. By using the operation device as mentioned above, an occupant restraining means such as the airbag 40 and a side airbag 41 can be properly actuated in the event of a vehicle collision, thereby improving the occupant restraint property.

As another embodiment, there may be provided a device for locking the seat belt when a child seat is attached or a device for informing thereof, using information about the rear-seat occupant (the presence or absence of the occupant, the seated position of the occupant), and/or a device for locking a door when a small-size occupant such as a child is seated or when a child seat is attached or a device for informing thereof, using the aforementioned information about the rear-seat occupant.

According to the occupant detection apparatus 100 of this embodiment as mentioned above, there can be provided a seat belt apparatus and/or an airbag apparatus capable of controlling by using information about the rear-seat occupant in the vehicle rear seat 12 precisely detected by the respective processes based on the three-dimensional images taken by the 3D camera 112. In addition, there can also be provided a vehicle to which such a seat belt apparatus and/or such an airbag apparatus are installed.

Japan Priority Application 2007-105120, filed Apr. 12, 2007 including the specification, drawings, claims and abstract, is incorporated herein by reference in its entirety.

The present invention is not limited to the aforementioned embodiments and various applications and modifications may be made. For example, though the aforementioned embodiments have been described with regard to the arrangement of the occupant detection apparatus 100 to be installed in an automobile, the present invention can be adapted to occupant detection apparatuses to be installed in various vehicles such as an automobile, an airplane, a boat, a bus, and a train.

It is also important to note that the arrangement of the occupant detection apparatus, as shown, are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited herein. Many modifications are possible without departing from the scope of the invention unless specifically recited in the claims. Accordingly, all such modifications are intended to be included within the scope of the present disclosure as described herein. The order or sequence of any process or method steps may be varied or re-sequenced according to alternative embodiments. Other substitutions, modifications, changes, and/or omissions may be made in the design, operating conditions and arrangement of the preferred and other exemplary embodiments without departing from the exemplary embodiments of the present disclosure as expressed herein.

What is claimed is:

1. An occupant detection apparatus comprising:
a photographing section that is disposed to face to a vehicle rear seat in a vehicle cabin for taking three-dimensional images of the vehicle rear seat area;
an information extraction processing section that extracts only first image information about an upper area of a seat back of the vehicle rear seat area from the three-dimensional images taken by the photographing section including the first image information and second image information about areas other than the upper area of the seat back;
a segmentation processing section that segments the first image information extracted by the information extraction processing section into areas relating to respective sitting areas of a plurality of rear-seat occupants sitting in the vehicle rear seat; and
an derivation processing section that derives, with regard to each image information segmented by the segmentation processing section, information about the rear-seat occupant sitting in each sitting area of the vehicle rear seat, based on the percentage of the occupant information occupying a two-dimensional image at a position spaced apart from the photographing section by a reference distance.

2. An occupant detection apparatus comprising:
a photographing section which is disposed to face to a vehicle rear seat in a vehicle cabin for taking three-dimensional images of the vehicle rear seat area;
an information extraction processing section which extracts only first image information about an upper area of a seat back of the vehicle rear seat area from the three-dimensional images taken by the photographing section including the first image information and second image information about areas other than the upper area of the seat back;
a segmentation processing section which segments the first image information extracted by the information extraction processing section into areas relating to respective sitting areas of a plurality of rear-seat occupants sitting in the vehicle rear seat; and
an derivation processing section which derives, with regard to each image information segmented by the segmentation processing section, information about the rear-seat occupant sitting in each sitting area of the vehicle rear seat, based on the volume of a detected object in each sitting area.

3. An operation device control system comprising:
an occupant information detector for detecting information about a rear-seat occupant sitting in a vehicle rear seat; and
an operation device which is actuated according to the detection result of the occupant information detector, wherein
the occupant information detector is composed of an occupant detection apparatus as claimed in claim 1 and the operation device is actuated according to the information derived by the derivation processing section of the occupant detection apparatus.

4. A seat belt system that is installed in a vehicle, comprising:
an occupant detection apparatus as claimed in claim 1;
a seat belt which can be worn by a rear-seat occupant sitting in a vehicle rear seat for restraining the rear-seat occupant;
a seat belt buckle which is installed in each sitting area of the vehicle rear seat;
a tongue which is attached to the seat belt and is latched with the seat belt buckle during the seat belt wearing state; and
an informing section for informing of the position of at least either of the seat belt buckle and the tongue for each sitting area of the vehicle rear seat when it is determined that the rear-seat occupant is sitting in the sitting area of the vehicle rear seat based on the information derived by the derivation processing section of the occupant detecting apparatus.

5. A seat belt system as claimed in claim 4, wherein the informing section informs of the positions of the seat belt buckle and the tongue which are correctly latched with each other during the normal seat belt wearing state.

6. A seat belt system that is installed in a vehicle, comprising:
an occupant detection apparatus as claimed in claim 1;
a seat belt which can be worn by a rear seat occupant sitting in a vehicle rear seat for restraining the rear-seat occupant;
a seat belt buckle which is installed in each sitting area of the vehicle rear seat;
a tongue which is attached to the seat belt and is latched with the seat belt buckle during the seat belt wearing state;
a buckle detecting sensor for detecting that the tongue is latched with the seat belt buckle; and
an output section for outputting the wearing completion of the seat belt, based on the information derived by the derivation processing section of the occupant detecting apparatus and the detection result by the buckle detecting sensor.

7. A vehicle comprising:
an engine/running system;
an electrical system;
a vehicle control device for controlling the actuation of the engine/running system and the electrical system; and
an operation device control system as claimed in claim 3.

8. A vehicle comprising:
an engine/running system;
an electrical system;
a vehicle control device for controlling the actuation of the engine/running system and the electrical system; and
a seat belt apparatus for restraining a rear-seat occupant sitting in a vehicle rear seat by a seat belt, wherein
the seat belt apparatus is a seat belt apparatus as claimed in claim 4.

9. An occupant detection apparatus comprising:
a photographing device disposed to face to a vehicle rear seat in a vehicle cabin for taking three-dimensional images of the vehicle rear seat area, wherein the images include first image information about an upper area of a seat back of the vehicle rear seat area and second image information about areas other than the upper area of the seat back;
a controller including an information extraction processing section configured to extract only the first image information from the three-dimensional images,;
wherein the controller includes a segmentation processing section configured to segment the first image information extracted by the information extraction processing section into areas relating to respective sitting areas of a plurality of rear-seat occupants sitting in the vehicle rear seat; and
wherein the controller includes an derivation processing section configured to derive, with regard to each image information segmented by the segmentation processing section, information about the rear-seat occupant sitting in each sitting area of the vehicle rear seat, based on the percentage of the occupant information occupying a two-dimensional image at a position spaced apart from the photographing device by a reference distance.

10. The system of claim 9, wherein the controller further comprises an image processing unit configured to control the image capturing device to adjust the quality of the taken image.
